(19) United States
(12) Patent Application Publication
(10) Pub. No.: US 2007/0271202 A1
(43) Pub. Date: Nov. 22, 2007

(54) DETERMINING CONTENT PRICING FOR CATEGORIES OF USE BASED ON EXTRINSIC AND INTRINSIC FACTORS

(75) Inventor: Glen Arthur O'Connor, Renton, WA (US)

Correspondence Address: Corbis Corporation;c/o DARBY & DARBY P.C., P.O. BOX 770, Church Street Station, NEW YORK, NY, 10008-0770, US

(73) Assignee: Corbis Corporation, Seattle, WA (US)

(21) Appl. No.: 11/382,204

(22) Filed: May 8, 2006

(51) Int. Cl. G06F 17/00

(52) U.S. Cl. 705/400

(57) ABSTRACT

Automatically determining pricing for at least one unit of content that can be selected and purchased over a network for one or more of a plurality of predetermined categories of use and in one or more formats. Also, one or more sources can provide intrinsic and extrinsic value factors that can be associated with units of content. Further, one or more of these sources can be separate from the actual source of the content. Additionally, one or more of these factors can be manually and/or automatically processed or preprocessed to determine a price for a unit of selected content for at least one of the plurality of predetermined categories of use. This processing can include one or more methods, including, but not limited to, normalization, weighting, coalescing, and statistical analysis.

### FIELD OF THE INVENTION

The present invention relates to determining a price for digital content, and more particularly, for determining pricing for digital content for one or more uses based on intrinsic and extrinsic factors.

### BACKGROUND OF THE INVENTION

Content can generally include, but is not limited to, images, pictures, videos, illustrations, drawings, graphics, symbols, text, and audio recordings. Also, content can be digitized and embodied in an electronic format that can be communicated over a network and/or included in a processor readable media. Typical customers of such content for commercial purposes include advertisers, publishers, media companies, graphic designers, editors, art directors, artists, writers, and the like. Additionally, sellers of digital content often employ several different methods for determining prices for the use of selected content.

One method for a seller to determine a price for content is the Rights Managed (RM) pricing model. For example, the seller determines a particular price for content selected by a customer that further provides an intended type of use, territory of use, start date, duration, industry, and type/size of an electronic format for the selected content. The RM model enables customization of a particular price for selected content for each customer, but it can also be expensive for the seller to administer and somewhat cumbersome and time consuming for customers to use.

Another method sellers employ to determine customer pricing for content is the Royalty Free (RF) model. For example, based on the selection of a particular electronic format/size, a fixed price is determined in advance for most every popular use of the content. The RF model can be less expensive for a seller to administer than the RM model and relatively easy for customers to use. However, in some cases, the RF model can provide prices for content that may be too low for some uses and too high for other uses. Consequently, sales of content priced with the RF model may be lost because the fixed price is too expensive (too far removed) from the customer's actual use. Also, the seller may forego substantial profits on content that has become more valuable since the fixed price was predetermined (fixed price was set too low).

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 illustrates a system diagram of one embodiment of an environment in which the invention may be practiced;

FIG. 2 shows one embodiment of a mobile device that may be included in a system implementing the invention;

FIG. 3 illustrates one embodiment of a network device that may be included in a system implementing the invention;

FIG. 4 shows a logical flow diagram generally showing one embodiment of a process for determining prices for selected content based on one or more intrinsic and/or extrinsic value factors;

FIG. 5 illustrates a logical flow diagram of a process for customizing categories of use and/or pricing for content that is subsequently displayed for sale to one or more customers;

FIG. 6 shows a logical flow diagram for determining prices for categories of use for content in response to their selection by a customer;

FIG. 7 illustrates a logical flow diagram for determining prices for categories of use for content in advance of their selection by a customer;

FIG. 8 shows a logical flow diagram for processing value factors which can be generally applied to both intrinsic value factors and extrinsic value factors;

FIG. 9 illustrates a display of an exemplary page, which includes five images that are the result of a search on the word “jazz”;

FIG. 10 shows a display of a display of a page, which is the result of selecting the image in a search results page; and

FIG. 11 illustrates a display of a page which depicts help information that explains a royalty free plus pricing model to a customer in accordance with the invention.

### DETAILED DESCRIPTION OF THE INVENTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods, or devices. Accordingly, the present invention may take the form of an entirely hardware embodiment, an entirely software embodiment or an embodiment combining software and hardware aspects. The following detailed description is, therefore, not to be taken in a limiting sense.

The invention is generally directed to a method, system, apparatus, and processor readable media for automatically determining pricing for at least one unit of content that can be selected and purchased over a network for one or more of a plurality of predetermined categories of use and in one or more formats. Also, one or more sources can provide intrinsic and extrinsic value factors that correspond to each unit of content. Further, one or more of these sources can be separate from an initial source or creator of the content. Additionally, one or more of these factors can be manually and/or automatically processed to subsequently determine a price for a unit of content for at least one of a plurality of predetermined categories of use. This processing can include one or more methods, including, but not limited to, normalization, arithmetic computations, functional analysis, weighting, coalescing, aggregation, and statistics.

In determining a price to offer a unit of content, different or somewhat similar weights can be associated with one or more of the extrinsic and intrinsic value factors. An intrinsic value factor can be based on at least one of, but not limited to, the following information: cost to obtain the content from a source; source of content, author of content, date of content creation, geographic locale of content creation, negotiated price to use the content for each of the plurality of predetermined categories of use; cost to manufacture the content in each format that can be made available to a customer; cost of media to provide content; and/or cost to store the content.

Additionally, an extrinsic value factor can be based on at least one of, but not limited to, the following information: a collection of content; current and/or past sales history; content stored in shopping carts; promotions; reviews; popularity; industry; weather; season; death and/or destruction of content subject; holidays; events; anniversaries; ranking; models; production; reproducibility; designation; use; renown of the content's author; renown of the content; search result hits; and the like.

In one embodiment, the plurality of predetermined uses presented to each customer can be relatively the same. In another embodiment, the plurality of predetermined uses can be custom tailored to a particular customer based at least in part on a profile. In yet another embodiment, the plurality of predetermined uses can be more custom tailored to typical applications in a particular industry, events, or promotions that are associated with the customer. In still another embodiment, the customer is provided with an interface for customizing a grouping of one or more of the predetermined uses.

In one embodiment, prior to the presentation of content for selection by a customer for one of the predetermined uses, the intrinsic and/or extrinsic value factors can be preprocessed and employed to determine a price for units of the content. This preprocessing can include one or more methods, including, but not limited to, normalization, functional analysis, weighting, coalescing, aggregation, and statistics. In another embodiment, the processing of the extrinsic and intrinsic value factors can be performed in real time for each unit of content selected by the customer for one of the predetermined plurality of uses.

In a further embodiment, a third party reseller of content is provided with access to the plurality of predetermined uses and determined price for each unit of content. An interface may be provided along with access to the content that enables the reseller's customers to have relatively automatic access to the determined pricing. In a still further embodiment, access to the determined pricing is provided to the reseller through an application programming interface (API) and/or some other mechanism(s) that enables the reseller to incorporate the pricing information directly into their system for selling to customers.

In yet another embodiment, the customer may select content for one of the predetermined uses with stationary and/or mobile devices coupled to at least one of a wired or wireless network. Additionally, the invention enables content and the determined pricing for predetermined uses to be accessible to customers in one or more ways, including, but not limited to, a networked service such as provided by a web server and/or File Transfer Protocol (FTP) server, mobile device interface, downloadable and/or installable application, and/or a Digital Asset Management (DAM) system.

In yet a further embodiment, the predetermined categories of use for the invention can include, but are not limited to, as follows: all uses, above the line, below the line, internal, editorial, and Web (Internet) Only. Table 1, as listed below, provides further detail for one embodiment of the invention regarding each of a plurality of exemplary predetermined categories of use.

TABLE I
Predetermined Categories of Use For Royalty Free Plus

| Usage | Description |
|---|---|
| All Uses | Unlimited perpetual use for all categories |
| Above the Line | Unlimited perpetual use for advertisements and |
| | promotions, including print ads (magazine, |
| | newspaper, free standing inserts, directories), |
| | paid space Web advertisements, outdoor displays |
| | (billboards, hoardings, banners) and TV/cinema |
| | commercials. |
| Below the Line | Unlimited perpetual use for advertisements and |
| | promotions, including brochures/direct mail, |
| | sales materials, annual reports, in-store |
| | displays (electronic or print), e-mail, trade |
| | show displays and corporate/promotional web |
| | sites. |
| Web Only | Unlimited perpetual use for paid space web |
| | ads, corporate/promotional web sites and |
| | e-mails. |
| Internal | Unlimited perpetual use for distribution |
| | within a single company or organization for |
| | collateral, presentations, training, e-mail |
| | or intranet uses. |
| Product Only | Unlimited perpetual use for product packaging, |
| | retail products, wall décor or |
| | incorporated in a TV/film/web entertainment |
| | program without promotion of a product, person, |
| | service or company. |
| Editorial (small) | Perpetual use in the context of a single |
| | editorial article, book (interior or cover) or |
| | broadcast whose purpose is to educate and/or |
| | convey news, information or fair comment |
| | opinion without direct promotion of a product, |
| | person, service of company. Limited to ½ page |
| | printed, ½ screen for web, or |
| | less than 5 seconds in a broadcast. |
| Editorial (large) | Perpetual use in the context of a single |
| | editorial article, book (interior or cover) or |
| | broadcast whose purpose is to educate and/or |
| | convey news, information or fair comment |
| | opinion without direct promotion of a product, |
| | person, service or company. Unlimited by size |
| | on a page, size on a screen, or display time |
| | in a broadcast. |

Additionally, although not shown in Table 1, a customer can aggregate particular categories of use. For aggregated categories of use, the determined pricing can be simply aggregated and/or discounted based on one more factors such as number of categories aggregated, customer profile, promotions, sales, cost, and the like. Furthermore, in some embodiments, customized categories of use may be provided based on a customer's profile, industry, promotion, and/or a particular collection of units of content.

In yet a further embodiment, the royalty managed pricing model can be modified with the invention to provide particular categories of use that are determined based on intrinsic and/or extrinsic value factors along with other categories of use that additionally require the customer to specify information such as specific use before a price is determined for selected content. For some embodiments, a listing such as Table 2 below could be displayed for selected content that employ the invention for a royalty managed plus pricing model. For this exemplary embodiment, hyper links are arranged for categories of use that require additional customer information before a price can be provided. As shown, determined prices are provided for those categories of use that can employ previously obtained value factors to determine a price (don't have to ask the customer for additional information to determine the price for selected content).

TABLE 2
Royalty-Managed Plus Content

| Usage | Price |
|---|---|
| All Uses | Specify Use (hyper-link) |
| Above the Line | Specify Use (hyper-link) |
| Below the Line | Specify Use (hyper-link) |
| Web Only | Specify Use (hyper-link) |
| Internal | $249 |
| Product Only | Specify Use (hyper-link) |
| Editorial (small) | $200 |
| Editorial (large) | $499 |

Illustrative Operating Environments

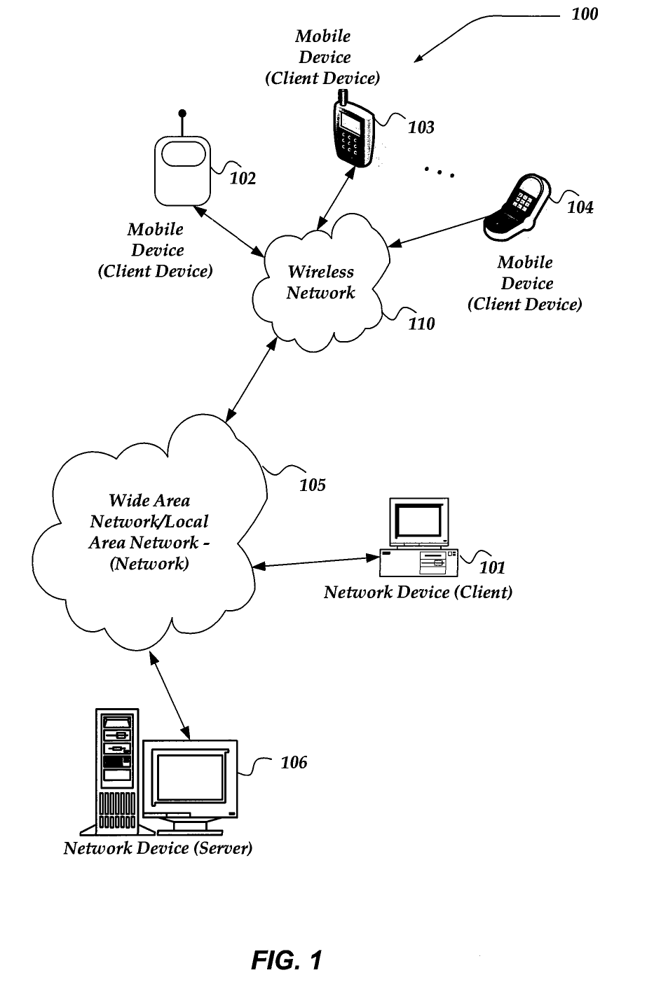

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 105, wireless network 110, server network device 106, mobile devices (clients) 102-104, and client network device 101.

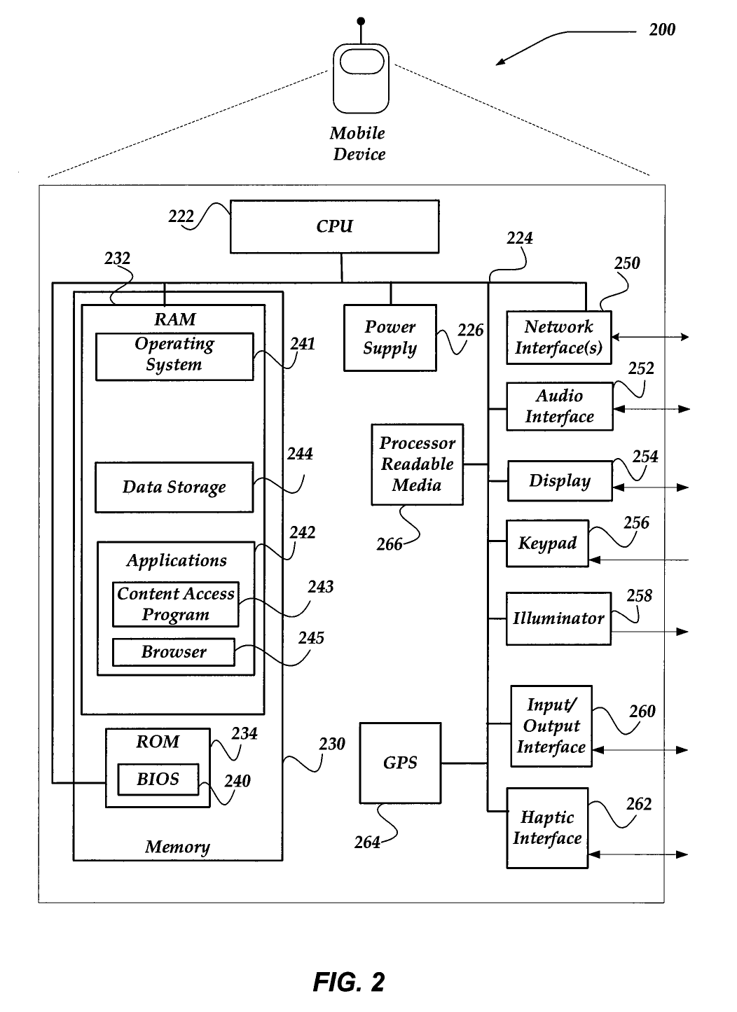

One embodiment of mobile devices 102-104 is described in more detail below in conjunction with FIG. 2. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, media players, video game consoles, multi-media computing platforms, integrated devices combining one or more of the preceding devices, and the like. As such, mobile devices 102-104 typically range widely in terms of capabilities and features. For example, a mobile telephone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol (WAP) message, and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102-104 also may include at least one other client application that is configured to receive content from another computing device. The client application may include a capability to provide and receive textual content, graphical content, audio content, and the like. This client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier. The information may also indicate a content format that the mobile device is enabled to process. Such information may be provided in a message, or the like, sent to server network device 106, or other computing devices.

Mobile devices 102-104 may also be configured to communicate a message, such as through Short Message Service (SMS), Multimedia Message Service (MMS), instant messaging (IM), internet relay chat (IRC), Mardam-Bey's IRC (mIRC), Jabber, and the like, between another computing device, such as Network Device 106, client device 101, or the like. However, the present invention is not limited to these message protocols, and virtually any other message protocol may be employed.

Mobile devices 102-104 and client network device 101 may further be configured to include a client application that enables a user to log into a customer account that may be managed by another computing device, such as server network device 106. Such customer account, for example, may be configured to enable the user to search for content, browse web pages, select content for purchase, and select uses for the selected content, or the like. However, participation in these activities may also be performed without logging into a customer account.

Client network device 101 may include virtually any computing device capable of communicating over a network to send and receive information, including social networking information, or the like. The set of such devices may include devices that typically connect using a wired or wireless communications medium such as personal computers, multiprocessor systems, microprocessor-based or programmable consumer electronics, network PCs, network appliances, or the like.

Wireless network 110 is configured in part to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, Wifi networks, Wimax networks, cellular telephone networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile devices 102-104 and another computing device, network, and the like.

Network 105 is configured to couple server network device 106 and its components with other computing devices, including, client network device 101, and through wireless network 110 to mobile devices 102-104. Network 105 is enabled to employ any form of processor readable media for communicating information from one networked electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between server network device 106, client device 101, and other computing devices.

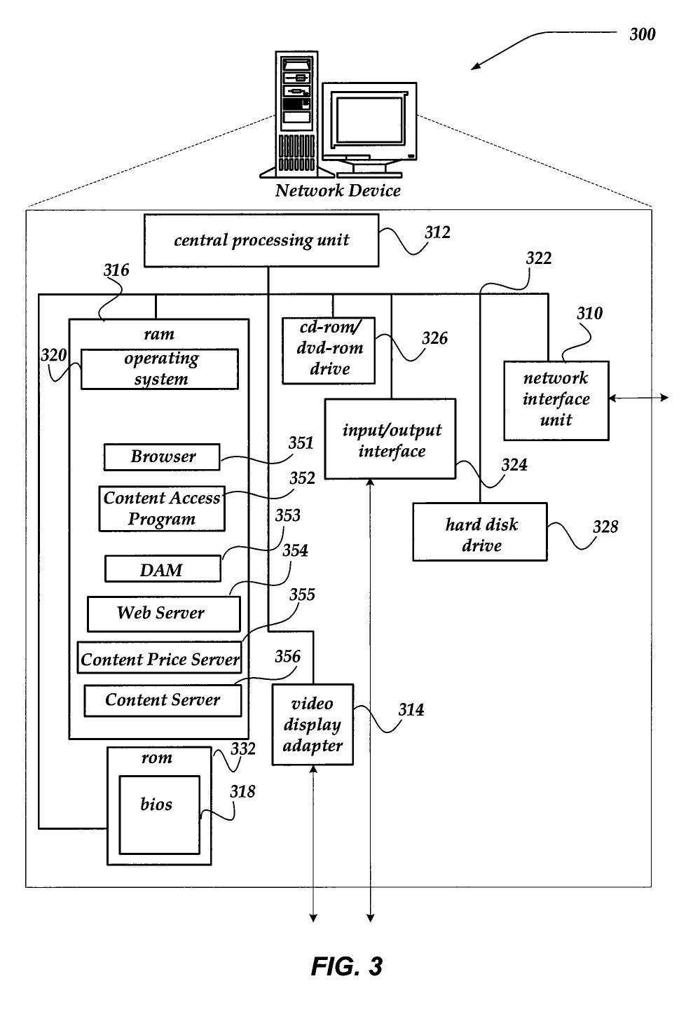

One embodiment of server network Device 106 is described in more detail below in conjunction with FIG. 3. Briefly, however, server network device 106 may include any computing device capable of connecting to network 105. Further, server network device 106 enables one or more server applications to communicate with clients and/or other server applications operating on other computing devices. The server applications can include, but are not limited to, one or more of content server 356, web server 354, content price server 355, and/or Digital Asset Management server 353. Further, server network device 106 can be arranged to include client applications such as browser 351, content access program 352, and the like.

Furthermore, although FIG. 1 illustrates server network device 106 as a single computing device, the invention is not so limited. For example, one or more functions or applications of server network device 106 may be distributed across one or more other network devices without departing from the spirit and scope of the invention.

Illustrative Mobile Client Environment

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, mobile devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264, and processor readable media 266. Media 266 may include, but is not limited to, hard discs, floppy disks, memory cards, optical discs, and the like. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is arranged for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like. Moreover, data storage 244 may also be employed to store social networking information including vitality information, or the like. At least a portion of the social networking information may also be stored on a disk drive or other storage medium (not shown) within mobile device 200.

Applications 242 may include computer executable instructions which, when executed by mobile device 200, transmit, receive, and/or otherwise process messages (e.g., SMS, MMS, IM, email, and/or other messages), audio, video, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may further include browser 245 and content access program 243.

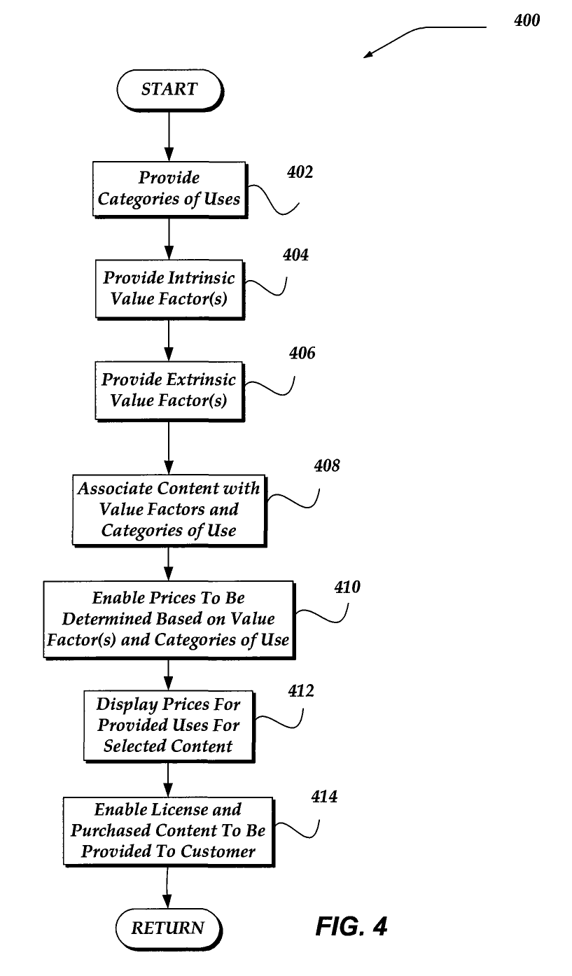

Content access program 243 may be configured either individually or in combination with browser 245 to enable searching and displaying of pages of selected content that is available for purchase for one or more uses that can be selected from predetermined categories. Program 243 can also enable a customer to aggregate categories of use. In one embodiment, content access program 243 enables a user to provide intrinsic value factors and/or extrinsic value factors for content that is subsequently priced in part on these factors and made available for purchase by customers over a network. Various embodiments of the processes for content access program 243 are described in more detail below in conjunction with FIGS. 4-11.

Illustrative Network Device

FIG. 3 shows one embodiment of a network device, according to one embodiment of the invention. Network device 300 may include many more components than those shown. The components shown, however, are sufficient to disclose an illustrative embodiment for practicing the invention. Network device 300 may be arranged to represent, for example, server network device 106 or client network device 101 of FIG. 1.

Network device 300 includes processing unit 312, video display adapter 314, and a mass memory, all in communication with each other via bus 322. The mass memory generally includes RAM 316, ROM 332, and one or more permanent mass storage devices with processor readable media, such as hard disc drive 328, tape drive, optical drive, memory card, and/or floppy disk drive. The mass memory stores operating system 320 for controlling the operation of network device 300. It is envisioned that any general-purpose or mobile operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, or network interface card (NIC).

The mass memory as described above illustrates another type of processor-readable media, namely computer storage media. Computer storage media may include volatile, nonvolatile, removable, and non-removable processor readable media implemented in any method or technology for storage of information, such as processor readable instructions, data structures, program modules, or other data. Examples of computer storage media include RAM, ROM, EEPROM, flash memory or other memory technology, CD-ROM, digital versatile disks (DVD) or other optical storage, memory cards, magnetic cassettes, magnetic tape, magnetic disk storage or other magnetic storage devices, or any other medium which can be used to store the desired information and which can be accessed by a computing device.

The mass memory also stores program code and data. One or more applications 350 can be loaded into mass memory and run on operating system 320. Examples of application programs that may be included are transcoders, schedulers, calendars, database programs, word processing programs, HTTP programs, customizable user interface programs, IPSec applications, encryption programs, security programs, VPN programs, SMS message servers, IM message servers, email servers, account management and the like.

If network device 300 is arranged as a client device, the client applications may include browser 351 and/or content access program 352. However, if network device 300 is arranged to operate and/or as a server, other serving applications may also be included, such as DAM 353, Web server 354, Content Price server 355, Content server 356, and the like. Furthermore, one or more of these serving applications may be arranged on one or more network devices dedicated to providing computing resources.

Content Price server 355 may be arranged to receive and process categories of use, intrinsic value factors, extrinsic value factors, and customized uses, customized pricing information, and the like. Content Price server 355 can preprocess information/data, process information/data in real time, or some combination of both to determine a price for a customer of selected content for one or more predetermined categories of use for the selected content. Also, the determination of the price can be based on one or more extrinsic value factors, intrinsic value factors, and predetermined categories of use. Furthermore, the determination of the price can be relatively static or dynamically updated in response to one or more changes to the information/data employed for determinations by Content Price Server 355. Generally, information and/or data can be provided for processing/preprocessing/determinations to Content Price Server 355 by one or more other servers, RSS feeds, APIs, applications, scripts, manual edits, third party sources, content providers, and the like.

Content server 356 can be arranged to provide access to content identification information so that the determined prices can be associated with the selected content. Web server 354 may also be arranged to provide the price information for selected content as a service to sources and/or resellers of selected content to customers. DAM 353 may also be arranged to incorporate the price information provided by Content Price server 355. Additionally, network device 300 is arranged to enable one or more of the processes described below in conjunction with FIGS. 4-11.

Generalized Operation

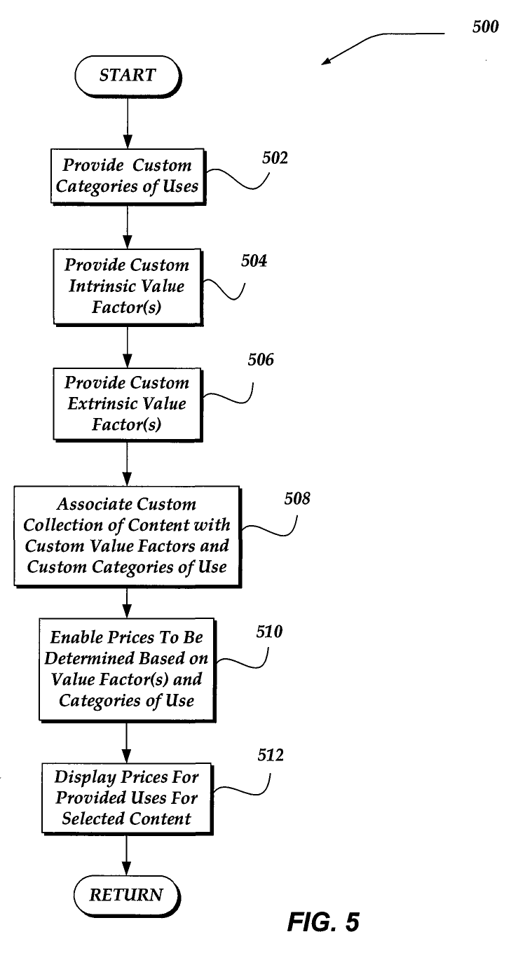

The operation of certain aspects of the invention will now be described with respect to FIGS. 4-8. FIG. 4 provides a general logical flow diagram, while FIGS. 5-8 provide examples of particular aspects of the processes to further illustrate the invention.

Thus, FIG. 4 illustrates logical flow overview 400 generally showing one embodiment of a process for determining prices for selected content based on one or more intrinsic and/or extrinsic value factors. Moving from a start block, the process steps to block 402 where one of a plurality of categories of use are provided. For example, these categories can include, but are not limited to, all uses, above the line, below the line, internal, editorial, and Web Only. Additionally, at least one of the plurality of categories of use can include a term of use, e.g., perpetual use or a fixed period of time. At block 404, the process is provided with at least one intrinsic value factor, as discussed above. Stepping to block 406, the process is provided with at least one extrinsic value factor, as discussed above.

Additionally, the extrinsic and intrinsic value factors and categories of use can be provided in one or more manual or automated ways, either singly or in combination, including, but not limited to, a Real Simple Syndication (RSS) feed, an Application Programming Interface (API), a program, a script, manual entry, and the like.

The process subsequently flows to block 408 where units of content are associated with the provided categories of use, intrinsic value factors, and extrinsic value factors. This association can be performed directly and/or indirectly with one or more data structures, databases, data stores, and the like. Also, as discussed elsewhere, the categories of use, intrinsic value factors, and extrinsic value factors, can be provided by one or more third party sources that can be separate from the actual source and/or author of the content. One or more methodologies may be employed to provide the categories of use and value factors, including, but not limited to, an API, RSS feed, manual editing,

At block 410, the process enables prices to be determined for content based on the intrinsic value factors, extrinsic value factors, and categories of use. The determining of the prices can occur in advance of the selection of content by the customer or it can occur in response to the customer's actions, i.e., selecting content for pricing.

At block 412, the determined prices for selected content are displayed for the customer for each of the available predetermined categories of use. In one embodiment, the determined prices are displayed at a user interface provided by a content provider that receives content from one or more content creators. In other embodiments, the determined prices are provided to resellers of content through an application programming interface (API), Real Simple Syndication (RSS) feed, a link to a page provided by a source and/or provider of content, or some other intermediate mechanism that enables substantially the same prices to be provided to a customer by a content provider and a reseller of selected content. Additionally, in some embodiments, the derived prices are dynamically updated based at least in part on one or more changes to at least one of the intrinsic value factor, extrinsic value factor, and weight.

At block 414, if the customer has purchased the selected content, the process enables a unit of the content to be provided to the customer along with a license to the predetermined category of use that the customer has paid for. In one embodiment, the unit of selected content could be a downloadable electronic file or stream of data, such as an audio file, video file, picture file, video stream, audio stream, and the like, over a wired and/or wireless network. In another embodiment, the unit of selected content could be provided as an electronic file on a removable processor readable media, such as a floppy disk, disc drive, optical disc, Flash Drive, and the like. In still other embodiments, the unit of content could be provided with a tangible and/or intangible product, such as a calendar, screen saver, poster, mouse pad, apparel, accessory, and the like. Next, the process returns to performing other actions.

FIG. 5 illustrates a logical flow overview 500 of a process for customizing categories of use and/or pricing for content that is subsequently displayed for sale to one or more customers. Moving from a start block, the process steps to block 502 where custom categories of use are provided. These categories of use can be custom tailored to a particular customer based at least in part on one or more of a customer profile, typical applications for a particular industry, events, geographic location of the customer, discounts, markups, and/or promotions. In one embodiment, the customer is provided with an interface for customizing one or more groupings of one or more of the predetermined uses.

At block 504, the process provides custom intrinsic value factors for at least a portion of the available content. These customized intrinsic value factors can reflect custom formats, modifications, sizes, and the like. Flowing to block 506, the process provides custom extrinsic value factors. These customized extrinsic value factors can include customer specific discounts, markups, geographic location of the customer, promotions, anniversaries, events, collections, industries, and other customer specific applications.

Advancing to block 508, the process associates a custom collection of content with the custom uses, intrinsic value factors, and extrinsic value factors. This association can be performed directly and/or indirectly with one or more data structures, databases, data stores, and the like. Also, as discussed elsewhere, the custom categories of use, custom intrinsic value factors, and custom extrinsic value factors, can be provided by one or more sources that can be separate from the actual source of the content.

Flowing to block 510, the process enables prices to be determined for content based on the custom intrinsic value factors, custom extrinsic value factors, and custom categories of use. The determining of the prices can occur in advance of the selection of content by the customer or it can occur in response to the customer's actions, i.e., selecting content for pricing.

At block 512, the prices for selected content are displayed for the customer for each of the available custom categories of use. In one embodiment, the determined prices are displayed at a user interface provided by a content provider that receives content from one or more content creators. In other embodiments, the determined prices are provided to resellers of content through an application programming interface (API), a link to a page provided by the content provider, or some other intermediate mechanism that enables substantially the same prices to be provided to a customer by the content provider and a reseller of selected content. Next, the process returns to performing other actions.

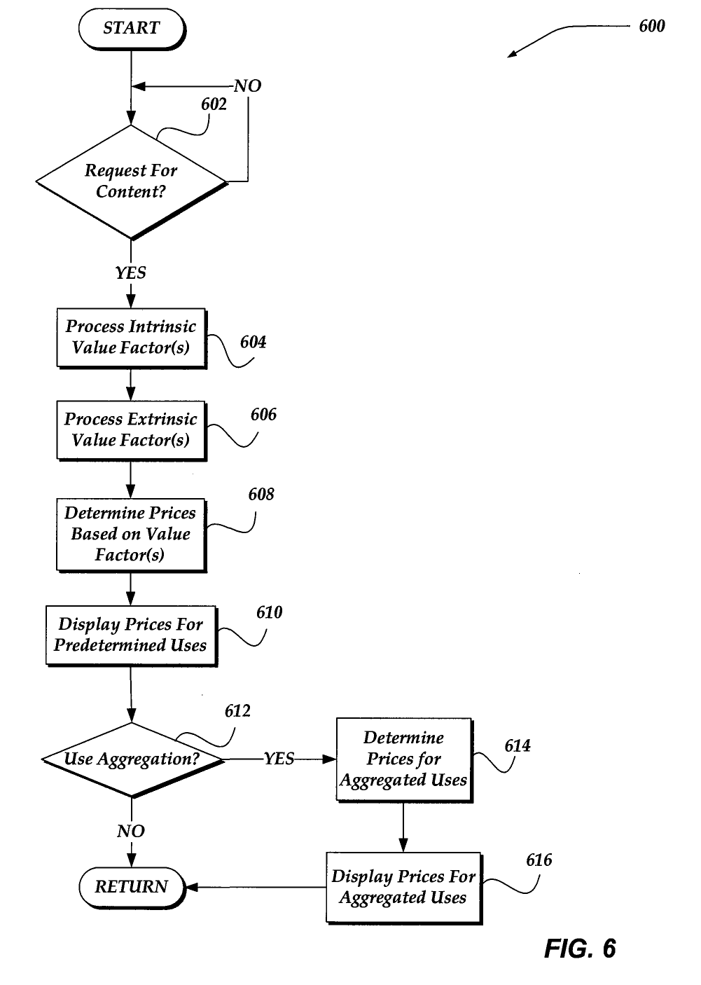

FIG. 6 illustrates a flow diagram for overview 600 of a method for determining prices for categories of use for content in response to their selection by a customer. Moving from a start block, the method moves to decision block 602, where a determination is made as to whether the customer is selecting content that is associated with at least one predetermined category of use. If not, the method waits until the determination is positive and then steps to block 604 where at least one of the intrinsic value factors associated with the selected content are processed. For example, the processing of the intrinsic value factors can include one or more of the processing steps that follow: normalization, functional analysis, weighting, coalescing, aggregation, and statistics. The intrinsic value factors can include at least the elements discussed above for FIG. 4, and elsewhere in the specification.

At block 606, the method processes at least one of the extrinsic value factors associated with the selected content. The extrinsic value factors can include at least the elements discussed above for FIG. 4, and elsewhere in the specification. The processing of the extrinsic value factors can include one or more of the processing steps that follow: normalization, functional analysis, weighting, coalescing, aggregation, and statistics. Flowing to block 608, the prices for selected content for the previously provided predetermined uses are determined based on the processed intrinsic value factors and extrinsic value factors.

Moving to block 610, the method enables the display of the determined prices for the predetermined categories of use for the requested content. The determined prices can be displayed at a user interface provided by a content provider that receives content from one or more content creators. In other embodiments, the determined prices are provided to resellers of content through an application programming interface (API), a link to a page provided by the content provider, or some other intermediate mechanism that enables substantially the same prices to be provided to a customer by the content provider and a reseller of selected content. Additionally, although not shown, in at least one embodiment, the prominence of the display of the requested content is based at least in part on at least one of the predetermined categories of use.

At decision block 612, a determination is made as to whether or not a customer has aggregated two or more predetermined categories of use for the selected content. If false, the method moves to the return block and returns to performing other actions. However, if the determination at decision block 612 is affirmative, the method steps to block 614 where a price is determined for the aggregated categories of use. At block 616, the newly determined prices for the aggregated categories of use are displayed. Next the method returns to performing other actions.

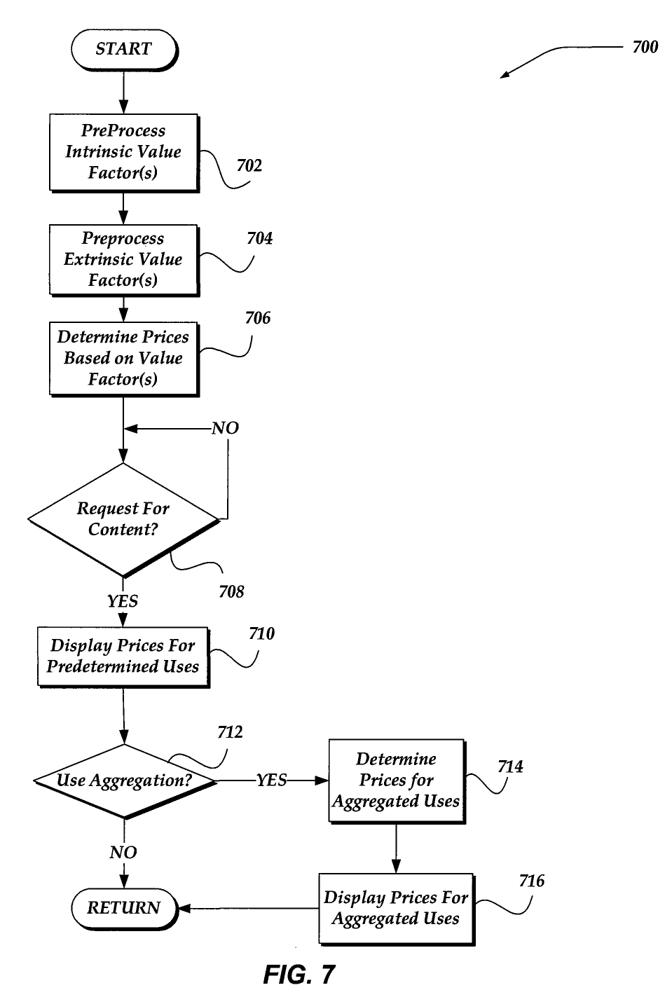

FIG. 7 illustrates a flow diagram for overview 700 of a method for determining prices for categories of use for content in advance of their selection by a customer. Moving from a start block, the method moves to block 702 where at least one of the intrinsic value factors associated with the selected content are preprocessed. For example, the processing of the intrinsic value factors can include one or more of the processing steps that follow: normalization, functional analysis, weighting, coalescing, aggregation, and statistics. The intrinsic value factors can include at least the elements discussed above for FIG. 4, and elsewhere in the specification.

At block 704, the method preprocesses at least one of the extrinsic value factors associated with the selected content. The extrinsic value factors can include at least the elements discussed above for FIG. 4, and elsewhere in the specification. The processing of the extrinsic value factors can include one or more of the processing steps that follow: normalization, functional analysis, weighting, coalescing, aggregation, and statistics. Flowing to block 706, the prices for selected content for the previously provided predetermined uses are determined based on the preprocessed intrinsic value factors and extrinsic value factors.

Advancing to decision block 708, a determination is made as to whether the customer is selecting content that is associated with at least one predetermined category of use. If not, the method waits until the determination is positive and then steps to block 710 where a display is provided for the previously determined prices for the predetermined categories of use. These previously determined prices can be displayed at a user interface provided by a content provider that receives content from one or more content creators. In other embodiments, the determined prices are provided to resellers of content through an application programming interface (API), Real Simple Syndication (RSS) feed, script, application, a link to a page provided by the content provider, manual edits, or some other intermediate mechanism that enables substantially the same prices to be provided to a customer by the content provider and a reseller of selected content. Additionally, although not shown, in at least one embodiment, the prominence of the subsequent display of the content is based at least in part on at least one of the predetermined categories of use.

At decision block 712, a determination is made as to whether or not a customer has aggregated two or more predetermined categories of use for the selected content. If false, the method moves to the return block and returns to performing other actions. However, if the determination at decision block 712 is affirmative, the method steps to block 714 where a price is determined for the aggregated categories of use. At block 716, the newly determined prices for the aggregated categories of use are displayed. Next the method returns to performing other actions.

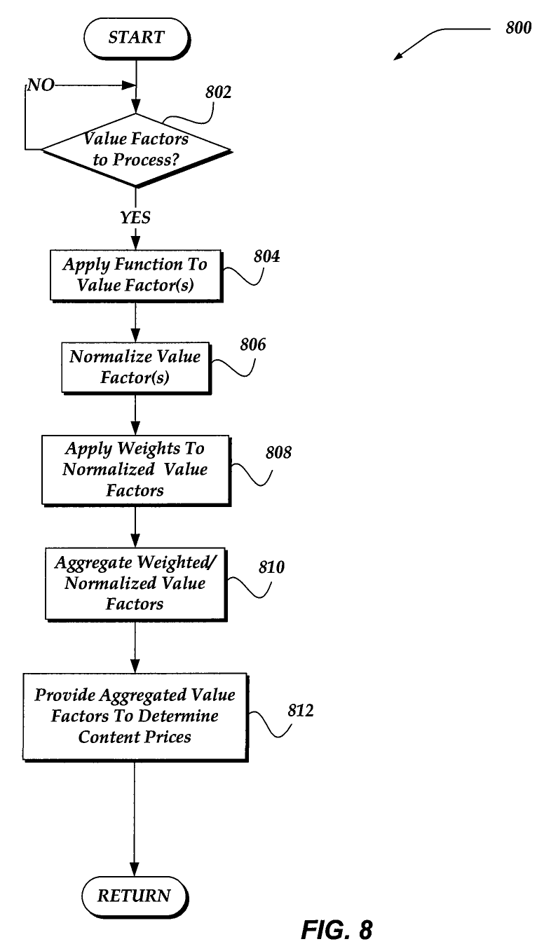

FIG. 8 illustrates a logical flow diagram overview 800 of a method to process value factors which can be generally applied to both intrinsic value factors and extrinsic value factors. Moving from a start block, the process flows to decision block 802 where a determination is made as to whether or not value factors have been provided for processing. The method waits until the determination is affirmative and advances to block 804 where, if applicable, functional operations are performed on the provided value factor. These functional operations can include arithmetic operations, rounding, frequency, equalization, logical operations, integer conversion, floating point conversion, statistical computations, coalescing, and the like.

Advancing to block 806, as appropriate the provided value factor is normalized to a scale and/or range provided for that particular type and/or kind of value factor. For example, each kind of the provided type of intrinsic value factors might be normalized to a scale of one to ten even if they were initially provided in different scales such as one to 100 or zero to five.

At block 808, appropriate weights are provided for the type and/or kind of value factor. For example, one or more of the extrinsic value factors might be associated with weights of 10% or less, where other kinds of the intrinsic value factors might be associated with weights of 50% or more.

Moving to block 810, the normalized and weighted value factors are aggregated by type. For example, the different kinds of intrinsic value factors are aggregated together and the different kinds of extrinsic value factors are aggregated together.

At block 812, the aggregated intrinsic value factors and the aggregated extrinsic value factors are subsequently provided for another process to determine prices for predetermined categories of use for selected content. In at least one embodiment, a change in one or more of the extrinsic and/or intrinsic value factors can be employed to dynamically adjust the aggregated amount of value factors over time. Additionally, one or more of the weights can be dynamically adjusted over time based at least in part on at least one change to one or more of the intrinsic and extrinsic value factors, and/or input from an API, RSS feed, manual editing, and the like. Next, the method returns to performing other actions.

It will be understood that each block of the above flowchart illustrations, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions executing on the processor provide steps for implementing the actions listed in the flowcharts discussed above.

Accordingly, blocks of the flowchart illustrations support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

Exemplary User Interface

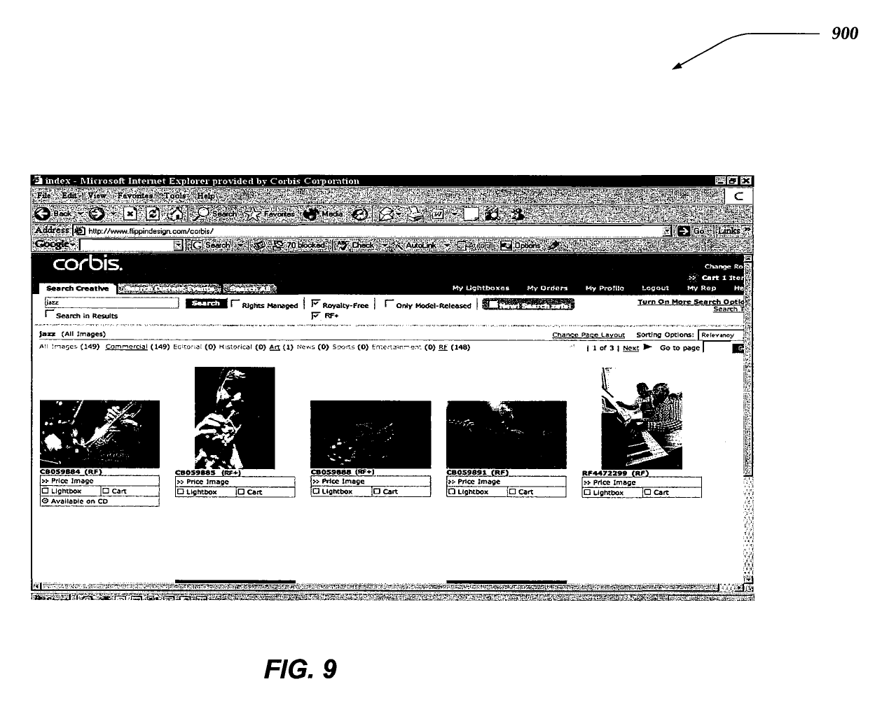

FIGS. 9, 10, and 11 illustrate exemplary pages that can be displayed to a customer to assist in selecting and purchasing content whose category pricing is determined by the invention.

FIG. 9 illustrates a display of page 900, which includes five images 902, 904, 906, 908, and 910 that are the result of a search on the word “jazz”. Three images (902, 904, 906) are displayed with an RF+ indicator and the other two images (908 and 910) include RF indicators. In this embodiment, the RF+ indicator identifies the corresponding content (image) as being available in a pricing format that is substantially similar, but somewhat different in positive ways, to the royalty free pricing model. The other content (images 908 and 910) display RF indicators that identify the standard royalty free pricing model.

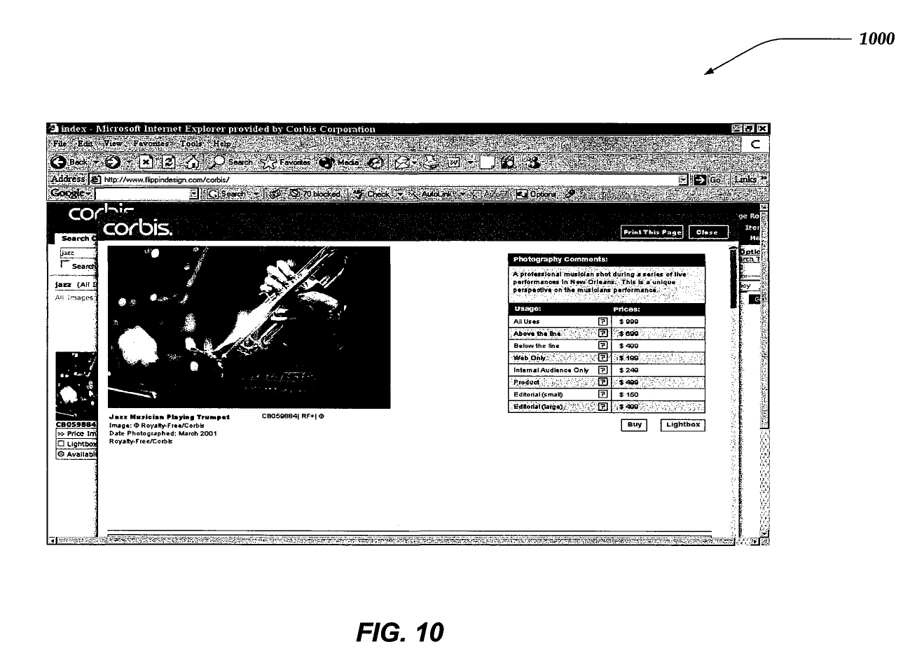

FIG. 10 illustrates a display of page 1000, which is the result of selecting image 902 in FIG. 9. Image 1002 is a higher resolution display of the selected content which includes its title and related usage information. Also, table 1004 is displayed which includes a plurality of predetermined categories of use and the determined prices for each category. Annotation 1006 can also include comments and/or text that indicate one or more factors that positively support a determined price for the selected content. Buy button 1008 is provided so that the customer can proceed to a check out facility and purchase the selected content. Also, light box (shopping cart) button 1010 is provided so that the customer can temporarily store the selected content for future consideration as a purchase. Additionally, although not shown, in at least one embodiment, the prominence of the display of content is based at least in part on one of the predetermined category of use. Furthermore, although not shown, a visual image may be displayed either singly or in combination with the annotation to indicate a prominence of selected content.

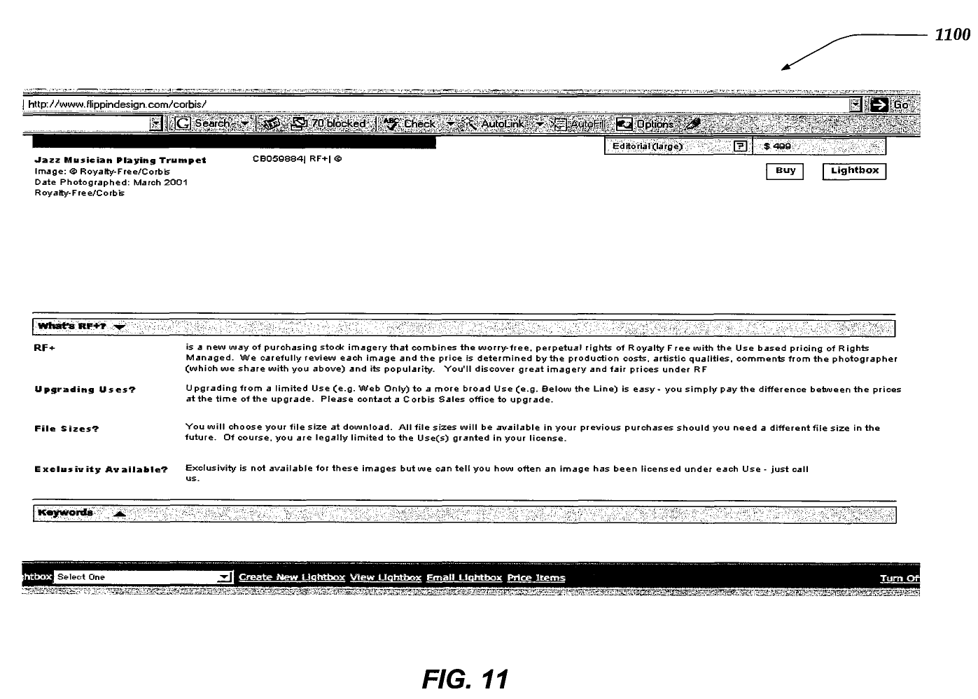

FIG. 11 illustrates a display of page 1100, which depicts help information 1102 that explains the royalty free plus pricing model to the customer. Help information 1102 also includes explanations regarding upgrading uses, files sizes, and exclusivity options.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for providing pricing to a customer for categorical use of content, comprising:
enabling an association of an intrinsic value factor with at least one unit of content;
enabling an association of an extrinsic value factor with at least one unit of content;
enabling an association of a plurality of predetermined categories of use with the at least one unit of content; and
determining a price for the at least one unit of content for at least one of the plurality of predetermined categories of use based at least in part on processing at least one of the intrinsic value factor or the extrinsic value factor that is associated with the at least one unit of content.

2. The method of claim 1, further comprising enabling the customer to select a display of the at least one unit of content and the determined price for at least one of the plurality of predetermined categories of use.

3. The method of claim 2, wherein the display of the determined price is dynamically updated in response to at least one change to at least one of the intrinsic value factor or the extrinsic value factor.

4. The method of claim 1, further comprising enabling a display of at least one of the plurality of predetermined categories of use or the determined price for the at least one unit of content in at least one format, wherein the format includes at least one of a list, table, graph, histogram, grid, or chart.

5. The method of claim 4, further comprising arranging the display based on at least one of the extrinsic value factor, intrinsic value factor, or at least one predetermined category of use.

6. The method of claim 1, further comprising providing the customer with a license to use the selected unit of content in at least one of the predetermined categories of use.

7. The method of claim 1, further comprising providing the customer with a license to use the selected unit of content for a category of use that is customized for a particular customer.

8. The method of claim 1, further comprising associating a period of time that the at least one unit of content is licensed for at least one of the plurality of predetermined uses.

9. The method of claim 1, further comprising associating an annotation for display with at least one unit of content, wherein an author of the annotation can include information provided by at least one of an editor, producer, director, actor, musician, photographer, model, content subject, historian, celebrity, another customer, or critic.

10. The method of claim 1, further comprising associating at least one annotation for display with the at least one unit of content based on at least one of popularity, preference, promotion, customer profile, an event, difficulty in obtaining content, reproducibility, production, subject matter, model, criticism, historical perspective, or author.

11. The method of claim 1, further comprising enabling the display of at least one visual indication of a prominence associated with the at least one unity of content.

12. The method of claim 1, further comprising employing at least one of a server, Real Simple Syndication (RSS) feed, Application Programming Interface, application, script, manual edit, third party source, or content provider to provide at least one of the intrinsic value factor, extrinsic value factor, or the plurality of predetermined categories of use.

13. The method of claim 1, wherein the intrinsic factor includes at least one of a cost to obtain the content from a source, source of content, author of content, date of content creation, geographic locale of content creation, negotiated price to use the content for each of the plurality of predetermined categories of use, cost to manufacture the content in each format that can be made available to a customer, cost of media to provide content, or cost to store the content.

14. The method of claim 1, wherein the extrinsic factor includes at least one of a collection of content, current sales history, past sales history, content stored in shopping carts, promotions, reviews, popularity, industry, weather, season, death of content subject, death of author, destruction of content subject, holiday, event, anniversary, ranking, model, production, reproducibility, designation, use, renown of author, renown of content, search result hits, and geographic location.

15. The method of claim 1, further comprising processing at least one of the intrinsic value factors and the extrinsic value factors, wherein the processing includes one or more of normalization, arithmetic computations, functional analysis, frequency, weighting, coalescing, aggregation, or statistics.

16. The method of claim 1, further comprising the processing of at least one of the intrinsic value factor and the extrinsic value factor is processed in response to the selection of the content, or in part preprocessed prior to the selection of the content.

17. A method for providing pricing to a customer for categorical use of content, comprising:
providing an intrinsic value factor regarding pricing of at least one unit of content;
enabling an association of a plurality of predetermined categories of use for the at least one unit of content; and
determining a price for the at least one unit of content for at least one of the plurality of predetermined categories of use based at least in part on processing the intrinsic value factor that is associated with the at least one unit of content.

18. A method for providing pricing to a customer for categorical use of content, comprising:
providing an extrinsic value factor regarding pricing of at least one unit of content;
enabling an association of a plurality of predetermined categories of use for the at least one unit of content; and
determining a price for the at least one unit of content for at least one of the plurality of predetermined categories of use based at least in part on processing the extrinsic value factor that is associated with the at least one unit of content.

19. A method for providing pricing to a customer for categorical use of content, comprising:
providing an intrinsic value factor regarding pricing of each unit of content;
providing an extrinsic value factor regarding pricing of each unit of content;
providing a plurality of predetermined categories of use for each unit of content;
determining a price for each unit of content for at least one of the plurality of predetermined categories of use based at least in part on processing the intrinsic value factor and the extrinsic value factor; and
enabling the customer to select a unit of content at the determined price for at least one of the plurality of predetermined categories of use.

20. A processor readable media that includes components for enabling actions that provide pricing to a customer for categorical use of content, comprising:
a first component for enabling an association of an intrinsic value factor with at least one unit of content;
a second component for enabling an association of an extrinsic value factor with the at least one unit of content;
a third component for enabling an association of a plurality of predetermined categories of use with the at least one unit of content; and
a fourth component for determining a price for the at least one unit of content for at least one of the plurality of predetermined categories of use based at least in part on processing at least one of the intrinsic value factor or the extrinsic value factor that is associated with the at least one unit of content.

21. A system for providing pricing to a customer for categorical use of content over a network, comprising:
a server that performs actions, including:
receiving an intrinsic value factor regarding pricing of each unit of content;
receiving an extrinsic value factor regarding pricing of each unit of content;
receiving a plurality of predetermined categories of use for each unit of content; and
determining a price for each unit of content for at least one of the plurality of predetermined categories of use based at least in part on processing the intrinsic value factor and the extrinsic value factor; and
a client that performs actions, comprising:
enabling the customer to select a unit of content at the determined price for at least one of the plurality of predetermined categories of use; and
enabling the customer to purchase the selected unit of content.

22. The system of claim 21, further comprising a mobile device that includes at least one application for enabling the actions of the client.

23. The system of claim 21, further comprising a network device that includes at least one application for enabling the actions of the server.

24. The system of claim 21, wherein the client performs further actions including enabling the customer to select a display of the at least one unit of content and the determined price for at least one of the plurality of predetermined categories of use.

25. The system of claim 24, wherein the display of the determined price is dynamically updated in response to at least one change to at least one of the intrinsic value factor or the extrinsic value factor.

26. The system of claim 21, wherein the client performs further actions including enabling a display of at least one of the plurality of predetermined categories of use or the determined price for the at least one unit of content in at least one format, wherein the format includes at least one of a list, table, graph, histogram, grid, or chart.

27. The system of claim 21, wherein the client performs further actions including providing the customer with a license to use the selected unit of content in at least one of the predetermined categories of use or a category of use that is customized for a particular customer.

28. The system of claim 21, wherein the client performs further actions, including displaying at least one of an annotation or a visual indicator for the at least one unit of content.

29. The system of claim 21, wherein the server performs further actions, including employing at least one of another server, Real Simple Syndication (RSS) feed, Application Programming Interface, application, script, manual edit, third party source, or content provider to receive at least one of the intrinsic value factor, extrinsic value factor, or the plurality of predetermined categories of use.

30. The system of claim 21, wherein the intrinsic factor includes at least one of a cost to obtain the content from a source, source of content, author of content, date of content creation, geographic locale of content creation, negotiated price to use the content for each of the plurality of predetermined categories of use, cost to manufacture the content in each format that can be made available to a customer, cost of media to provide content, or cost to store the content.

31. The system of claim 21, wherein the extrinsic factor includes at least one of a collection of content, current sales history, past sales history, content stored in shopping carts, promotions, reviews, popularity, industry, weather, season, death of content subject, death of author, destruction of content subject, holiday, event, anniversary, ranking, model, production, reproducibility, designation, use, renown of author, renown of content, search result hits, and geographic location.

32. The system of claim 21, wherein the server performs further actions, including processing at least one of the intrinsic value factors and the extrinsic value factors, wherein the processing includes one or more of normalization, arithmetic computations, functional analysis, frequency, weighting, coalescing, aggregation, or statistics.

33. The system of claim 21, wherein the server performs further actions, including processing at least one of the intrinsic value factor and the extrinsic value factor in response to the selection of the content, or in part preprocessed prior to the selection of the content.

34. A server for providing pricing to a customer for categorical use of content over a network, comprising:
a first component for enabling an association of an intrinsic value factor with at least one unit of content;
a second component for enabling an association of an extrinsic value factor with the at least one unit of content;
a third component for enabling an association of a plurality of predetermined categories of use with the at least one unit of content; and
a fourth component for determining a price for the at least one unit of content for at least one of the plurality of predetermined categories of use based at least in part on processing at least one of the intrinsic value factor or the extrinsic value factor that is associated with the at least one unit of content.

35. A client for providing pricing to a customer for categorical use of content over a network, comprising:
a first component for enabling the customer to select a unit of content at the determined price for at least one of a plurality of predetermined categories of use, wherein the determined price for each unit of content for at least one of the plurality of predetermined categories of use is based at least in part on processing at least one of an intrinsic value factor and an extrinsic value factor; and
a second component for displaying at least one of the plurality of predetermined categories of use and the determined price for at least the selected unit of content.

36. The client of claim 33, further comprising another component for enabling the client to operate as an application on at least one of a mobile device or a network device.
